(19) United States
(12) Patent Application Publication
(10) Pub. No.: US 2026/0320095 A1
(43) Pub. Date: Oct. 15, 2026

(54) CAPTURING USER ACTIVITY AS MEMORY FOR QUESTION-ANSWERING

(71) Applicant: Microsoft Technology Licensing, LLC, Redmond, WA (US)

(72) Inventors: Yinheng LI, Redmond, WA (US); Justin James WAGLE, Pacifica, CA (US); Kazuhito KOISHIDA, Shoreline, WA (US)

(73) Assignee: Microsoft Technology Licensing, LLC, Redmond, WA (US)

(21) Appl. No.: 19/178,666

(22) Filed: Apr. 14, 2025

(51) Int. Cl. G06F 16/334; G06F 16/3329; G06F 16/34; G06F 16/353; G06F 16/532; G06F 40/30

(52) U.S. Cl. CPC G06F 16/334; G06F 16/3329; G06F 16/345; G06F 16/353; G06F 16/532; G06F 40/30

(57) ABSTRACT

Implementations for capturing user activity as memory for question-answering are provided. One example includes a computing system comprising: processing circuitry and memory storing instructions that, during execution, cause the processing circuitry to: receive a query; perform semantic searching on an L2 index comprising a database of event summaries based on the query to retrieve an L2 answer comprising one or more relevant event summaries; generate one or more L1 answers based on the L2 answer using an L1 index comprising a database of screen summaries associated with a plurality of L0 screenshot images, wherein each of the one or more L1 answers comprises relevant screen summaries corresponding to L0 screenshot images associated with a respective relevant event summary; pass the query and the one or more L1 answers to a large language model to generate an answer to the query; and output the answer to the query.

### BACKGROUND

Large language models are artificial intelligence systems trained on large datasets, enabling them to perform various natural language tasks. Generally, large language models leverage deep learning techniques to understand and to generate natural language input/output for various tasks, including but not limited to text generation, machine translation, text summarization, question-answering, etc. A large language model can utilize various sources of memory to provide context within which it can perform its tasks. Implicit memory refers to the large language model's trained foundational knowledge, which is encoded in its model parameters. Working memory is a context window accessible during inference. For example, the large language model may have access to a database. Generally, working memory is limited by the architecture within which the large language model is implemented. A large language model can also utilize external memory modules that store and retrieve information beyond the model's inherent capabilities.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Implementations for capturing user activity as memory for question-answering are provided. One example includes a computing system comprising: processing circuitry and memory storing instructions that, during execution, cause the processing circuitry to: receive a query; perform semantic searching on an L2 index comprising a database of event summaries based on the query to retrieve an L2 answer comprising one or more relevant event summaries from the database of event summaries; generate one or more L1 answers based on the L2 answer using an L1 index comprising a database of screen summaries associated with a plurality of L0 screenshot images, wherein each of the one or more L1 answers comprises relevant screen summaries from the database of screen summaries corresponding to L0 screenshot images associated with a respective one of the one or more relevant event summaries; pass the query and the one or more L1 answers to a large language model to generate an answer to the query; and output the answer to the query.

### BRIEF DESCRIPTION OF THE DRAWINGS

FIG. 1 shows a schematic view of an example computing system for capturing user activity as memory.

FIG. 2 shows a data flow diagram of an example method for generating various indices for capturing user activity as memory, which can be implemented using the example computing system of FIG. 1.

FIG. 3 shows a data flow diagram of an example method for generating an L1 index that stores a database of screen summaries, which can be implemented using the example computing system of FIG. 1.

FIG. 4 shows a data flow diagram of an example method for generating an L2 index that stores a database of event summaries, which can be implemented using the example computing system of FIG. 1.

FIG. 5 shows a data flow diagram of an example method for performing question-answering queries using various indices that capture user activity as memory, which can be implemented using the example computing system of FIG. 1.

FIG. 6 shows a process flow diagram of an example method for capturing user activity as memory, which can be implemented using the example computing system of FIG. 1.

FIG. 7 shows a schematic view of an example computing environment in which the computer system of FIG. 1 may be enacted.

### DETAILED DESCRIPTION

Large language models (LLMs) are powerful tools capable of performing various natural language tasks, including but not limited to text generation, machine translation, text summarization, question-answering, etc. Generally, the LLMs perform these tasks using their implicit memory that were learned through the training process. To perform more personalized tasks, such as processing information relating to a specific scenario/user, use of additional memory systems can be advantageous. For example, LLM architectures for performing question-answering tasks relating to a user's past activities on a computer have been contemplated. The user's past activities are recorded on a memory system that emulates the user's computer interactions. Such systems can answer questions about the user's historical activities, remember user information for auto-fill, generate insights about the user, and provide personalized recommendations.

One type of memory system capable of emulating users' computer activities utilizes screenshot images that are continuously taken while the computer is being used. When users want to review their previous activities, they can submit a query to an LLM system, and screenshot images relevant to the query can be displayed. One naïve approach for implementing such a system involves implementing a retrieved augmented generation (RAG) system directly on top of the screenshot images. This system utilizes a multi-modal model, such as a vision language model, to answer queries relating to a specific screenshot. For example, RAG can answer a query such as “What music did the user play on the online video sharing platform?” by retrieving one or more relevant screenshot images based on keywords in the query. The relevant screenshot images and query are sent to an LLM, which uses the screenshot images to generate an answer.

Classic RAG techniques generally struggle with more complex or general questions about a user's activity, interests, and/or preferences. Typical implementations of RAG are only able to reason on top of K screenshot images. K is limited by the context size. For instance, typical RAG systems generally use K values of about three to five. Furthermore, RAG relies on keywords in a query that also appear in the screenshot images to determine relevancy. For abstract or general questions, it can be difficult to identify relevant screenshot image candidates. For example, RAG has a difficult time retrieving a screenshot image relating to a query keyword “meeting” unless the screenshot image contains the word “meeting.” This can be true even if the screenshot image clearly displays use of a video conferencing application. As such, there is still a gap between merely storing a user's historical activity and fully understanding it to deliver direct and meaningful information.

In view of the observations above, implementations for capturing user activities as memory for question-answering tasks are provided. The implementations disclosed herein provide a memory framework that is able to reason across relevant screenshot images to answer complex and personalized questions. As described above, a RAG system built on top of a collection of screenshot images for question-answering tasks based on retrieved images can be insufficient as a comprehensive memory system. A limited number of screenshot images may not always convey meaningful information about a user's activities. Instead, the implementations disclosed herein describe a memory system that can reason across a chronological sequence of screenshot images to gain a deeper understanding of the user's activities, interests, and preferences.

Capturing user activities as memory can be implemented in various ways. User activities can be captured through the use of screenshot images. In some implementations, the memory system utilizes an LLM to process screenshot images by generating descriptions for each screenshot image. The screenshot images can be clustered into detected events, and descriptions for the events can also be generated. These text descriptions are stored in indices that can be accessed by the LLM to use in search and question-answering tasks. The indices enable searching for relevant screenshot images based on concepts such as but not limited to activity, intent, user preference, and semantic summaries that contain terms not always present in the screenshot images.

The memory system can be implemented in various ways. In some implementations, the memory system implements a hierarchical system that stores user activity information using screenshot images that are captured throughout user sessions of computer activity. The screenshot images can be organized into a hierarchy based on user activity patterns. Observations are generated within each level of the hierarchy and can be utilized collectively as context for question-answering. In some implementations, the memory system includes various modules for generating and utilizing different databases for the hierarchical system. For example, the memory system can include an L1 module that generates an L1 index containing a database of screen summaries corresponding to a plurality of L0 screenshot images. The memory system can further include an L2 module that generates an L2 index containing a database of event summaries corresponding to clustered groups of screen summaries. For the purposes of this disclosure, the terms “L0,” “L1,” “L2,” etc. refer to hierarchical levels within the memory system as organizational nomenclature. In some implementations, the memory system further includes a profile module that captures user information and an RAG module that provides enhanced RAG information. The various modules provide context and memory that can be utilized by an LLM to perform question-answering tasks about historical user activities on a computer. Additionally, such context can be used for personalized tasks, such as recommendations.

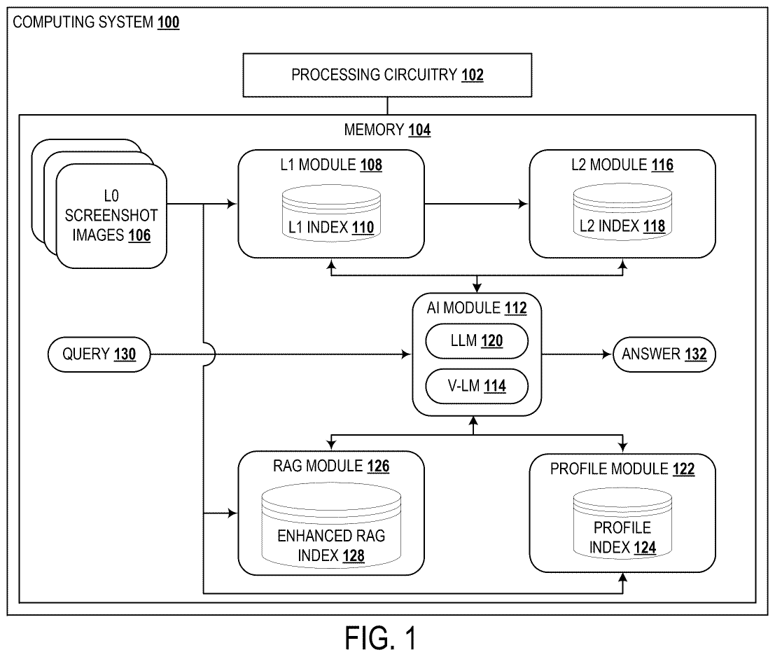

Turning now to the drawings, implementations of capturing user activity as memory are depicted and described in further detail. FIG. 1 shows a schematic view of an example computing system 100 for capturing user activity as memory. The example computing system 100 includes processing circuitry 102 and memory 104 storing instructions that, during execution, cause the processing circuitry 102 to perform the processes described herein. The example computing system 100 can be implemented with one or more of various types of computing devices, including but not limited to personal computers, servers, and mobile devices. For example, the computing system 100 can include a plurality of computing devices, and processing circuitry 102 and memory 104 may each include multiple components spread across multiple computing devices (e.g., processing circuitry 102 can include multiple processors within a single device or spread across multiple devices). The devices may be locally and/or remotely located. The example computing system 100 can also include non-depicted components for providing various functionalities, including components on individual computing devices.

The example computing system 100 includes various modules for implementing a memory system. The memory system takes, as input, a plurality of L0 screenshot images 106. The L0 screenshot images 106 can be provided in various ways. In some implementations, the L0 screenshot images 106 are taken automatically at regular intervals during a user session of computer activity. For example, the L0 screenshot images 106 can be taken using software and/or various operating system function calls. In other implementations, the L0 screenshot images 106 are taken manually in response to user input. The L0 screenshot images 106 can be formatted in various ways. For example, the L0 screenshot images 106 can include metadata describing various types of information, including but not limited to date taken, time taken, user account, etc. In some implementations, the L0 screenshot images 106 are stored in chronological order based on the time they were taken.

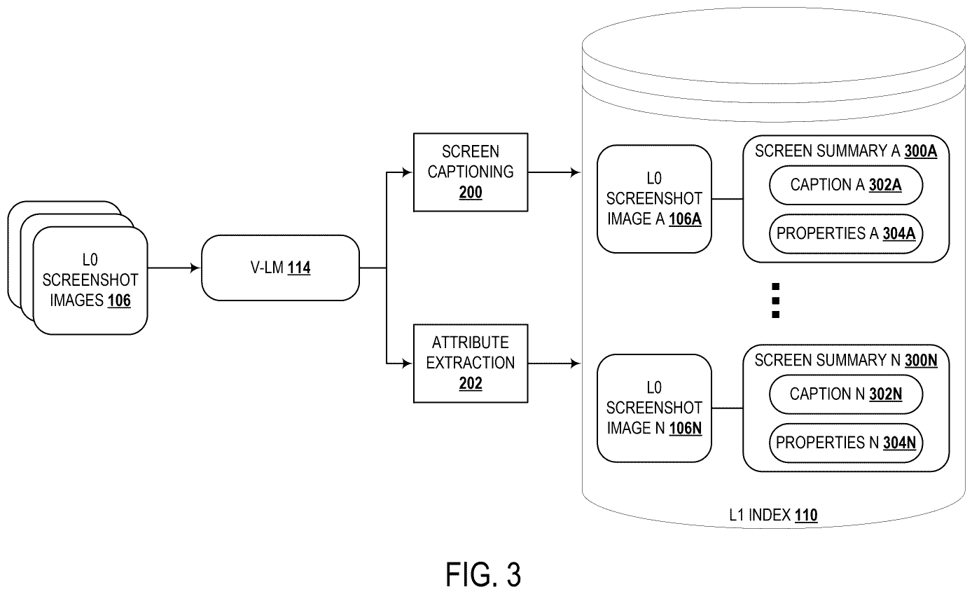

The memory system includes an L1 module 108 that generates an L1 index 110 using the plurality of L0 screenshot images 106. The L1 index 110 can be described as a low-level summary of the L0 screenshot images 106. The L1 index 110 can be implemented in various ways. In some implementations, the L1 index 110 stores a database of screen summaries corresponding to the L0 screenshot images 106. Screen summaries of the L0 screenshot images 106 can include various types of information and can be generated in various ways. In the depicted example, the L1 module 108 utilizes an artificial intelligence (AI) module 112 to process the L0 screenshot images 106, extracting and generating information that can be stored as screen summaries. FIG. 3 and its accompanying description describe the implementation of an L1 module and the generation of an L1 index in further detail.

Referring back to FIG. 1, the AI module 112 includes various machine learning models for this and other tasks. For example, in FIG. 1, the AI module 112 includes a vision-language model 114 (e.g., a vision-LLM or a vision-small language model) capable of processing the L0 screenshot images 106 to extract desired information for the L1 index 110. The vision-language model 114 can be implemented, for example, using a multi-modal model capable of processing input images and performing natural language tasks.

The memory system further includes an L2 module 116 that generates an L2 index 118 using the information from the L1 index 110. The L2 index 118 can be described as a summary of the L1 index 110 that defines events that occurred during the user activities. Events are useful for capturing high-level information about user activities and reducing noise from individual screenshot images. Events can be defined as sets of consecutive screenshot images that share similar attributes in the L1 index 110. For example, the screen summaries corresponding to the L0 screenshot images 106 can be compared for semantic similarity (e.g., similar activity, contiguous time period, etc.). Screen summaries (or L0 screenshot images 106) within a predetermined semantic similarity score threshold are clustered into an event. In some implementations, consecutive L0 screenshot images are clustered into an event.

Various methods can be utilized to calculate semantic distance. In some implementations, a transformer encoder model is utilized to embed information from the screen summaries of the L1 index 110. A vector cosine similarity score can be calculated from the embedded information between consecutive L0 screenshot images, and L0 screenshot images with similarity scores within the predetermined threshold are clustered into an event. Screen summaries of the L1 index 110 can include various types of information that can be used as a criterion for clustering. For example, an “activity” attribute that describes the activity the user is performing can be used for clustering. In another example, a “software platform” attribute describing the active software application is used for clustering. Different attributes may be weighed differently for the calculations of the semantic similarity scores.

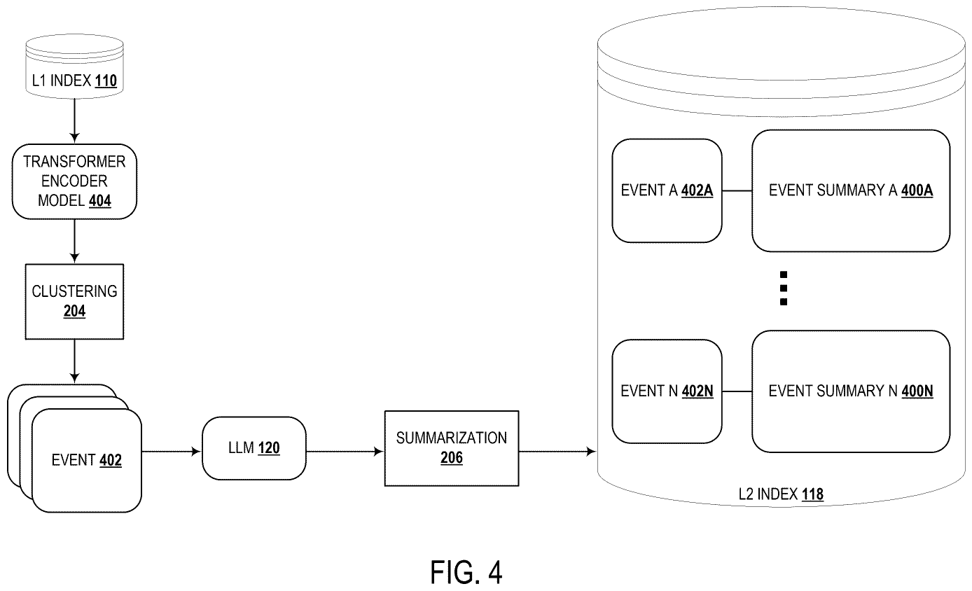

The L2 index 118 can be formatted in various ways. In some implementations, the L2 index 118 includes a database of event summaries corresponding to events determined through the clustering of the screen summaries in the L1 index 110. In the depicted example, the L2 module 116 utilizes the AI module 112 to generate the event summaries. Various types of machine learning models can be utilized. For example, the AI module 112 includes a text-only LLM 120 that can be used to generate a summary of the event based on the L1 index 110. Information such as the screen summaries corresponding to the L0 screenshot images 106 of a given event can be summarized by the LLM 120 to generate an event summary in a narrative form. Such implementations of the L2 module 116, along with the L1 module 108, create a user activity narrative over sequences of L0 screenshot images 106. FIG. 4 and its accompanying description describe the implementation of an L2 module and the generation of an L2 index in further detail.

Referring back to FIG. 1, the memory system further includes a profile module 122 that generates a profile index 124 using the L0 screenshot images 106. The profile index 124 can be formatted in various ways. Generally, the profile module 122 is implemented to capture information about a user from the L0 screenshot images 106 and store them in the profile index 124 within different user profiles. User profile information can include factual information such as a user's name, gender, email address, physical address, etc. User profile information can also include factual information relating to user activity, such as a trip destination, a flight number, a reservation number, etc. In some implementations, the user profile information includes inferred information from user activity, such as user interest, user preference, etc. For example, information about recent active software applications, recent contacts, etc. can be utilized.

User profile information can be extracted and generated in various ways. In some implementations, a vision-LLM, such as the vision-language model 114 of the AI module 112, is utilized to extract profile information from the L0 screenshot images 106. The vision-LLM can be presented with a prompt containing instructions to extract profile information in accordance with predetermined attribute. For example, the prompt can describe that the vision-LLM is presented with a screenshot image of a user's activity and instructs the vision-LLM to extract user profile information in a predetermined format. For example, the predetermined format can be in the form of key-value pairs. The prompt may also provide formatted examples. As can readily be appreciated, not every L0 screenshot image 106 will contain relevant profile information. In such cases, the vision-LLM can output a predetermined response, such as “unknown.”

In some implementations, the prompt can include less structured examples, and the vision-LLM can extract and output profile information with variances in formatting. For example, the vision-LLM may extract a “phone number” from one L0 screenshot image and a “cell number” from another image. To provide flexibility, a merging process can be performed that reconcile non-substantive differences. Similarly, when new L0 screenshot images are taken and processed, the profile module 122 can merge and update the profile index 124 accordingly. The merging process can be performed in various ways. In some implementations, the profile index 124 is updated upon receiving new profile information. For example, the vision-LLM can extract new profile information as a set of key-value pairs when new L0 screenshot images are received. For each incoming key, the merging process can, for example, retrieve the top K (e.g., K=3) most similar existing keys using semantic similarity (e.g., cosine score of embedded vectors for the keys). Any K can be used. The retrieved keys and values can then be concatenated and compared to the incoming new key-value pairs. To merge the existing and incoming keys, an LLM such as LLM 120 of the AI module 112 can be used to compare them and decide whether to append the new profile information or to overwrite the old profile information based on the content. For example, a change of address can be overwritten while a new email address can be appended. The LLM then generates a new set of key-value pairs, which are used to update the existing profile index 124.

The memory system further includes a RAG module 126 that generates an enhanced RAG index 128 using the L1 index 110 and the L0 screenshot images 106. The enhanced RAG index 128 can be implemented in various ways. In some implementations, the L1 index 110 is reused as additional context to enhance RAG performance. For example, when keywords do not appear on the screenshot images, such as general activities or concepts, classic RAG techniques generally fail. However, using the L1 index 110 as additional context can provide better matching. In some implementations, OCR is performed on the L0 screenshot images 106, and the results are appended to the corresponding screen summaries in the L1 index 110 to form the enhanced RAG index 128.

Utilizing some or all of the indices generated by the L1 module 108, the L2 module 116, the profile module 122, and the RAG module 126, the memory system is able to perform question-answering tasks using such indices as context to provide more accurate answers. For example, in response to a query 130 by a user to obtain answers based on the L0 screenshot images, the memory system can utilize the text information in the various indices 110, 118, 124, and 128 as memory to generate an answer. In addition to user-initiated queries, the memory system can also generate queries for downstream tasks.

The memory system can process a query 130 in various ways. In the depicted example, the query 130 is handled by the AI module 112. For example, the LLM 120 can be utilized to answer the query. In some implementations, query expansion and/or decomposition can be performed to enhance matching. The architecture for answering the query 130 can be implemented in various ways. In one example, the process includes performing a semantic search (e.g., lexical search, semantic vector search, a hybrid search, etc.) on the L2 index 118. This can be implemented as a text-only search. The L2 module 116 provides an L2 answer (e.g., list of event summaries that are relevant to the query 130). For each event in the L2 answer, an L1 answer can be provided by the L1 module 108. For example, the process can include retrieving relevant screen summaries for each of the event summaries listed in the L2 answer. The L1 answers and the query 130 can then be utilized by the LLM 120 to generate the answer 132 to the query 130. In some implementations, the profile module 122 and the RAG module 126 are utilized to respectively provide a profile answer and a RAG answer, which can also be utilized by the LLM 120.

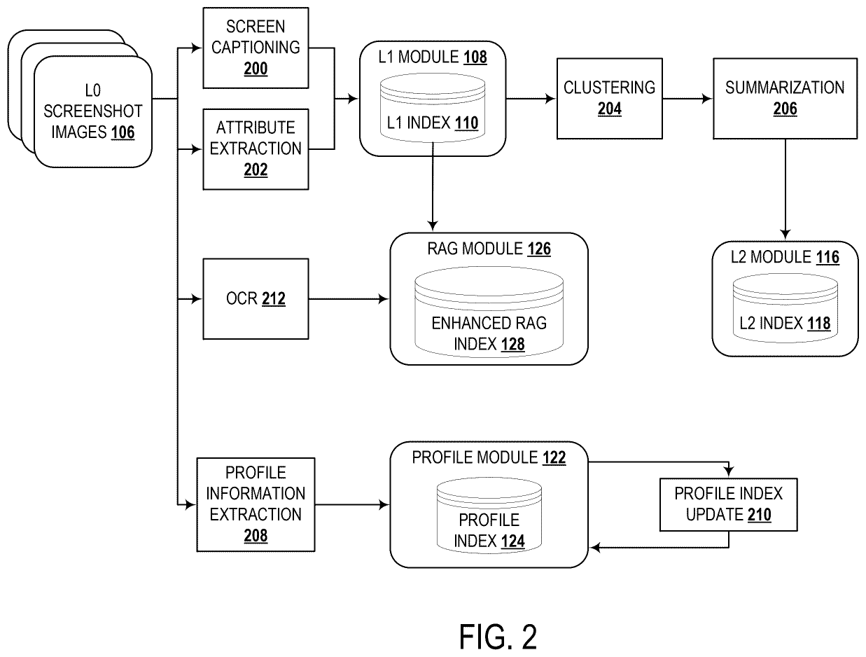

FIG. 2 shows a data flow diagram of an example method for generating various indices for capturing user activity as memory. The process starts with providing a plurality of L0 screenshot images 106 as input. As described above with respect to FIG. 1, the L0 screenshot images 106 can be provided in various ways. For example, they can be acquired automatically at regular intervals during computer usage using software and/or built-in operating system functions. The process utilizes the L0 screenshot images 106 and intermediate results to generate various indices. In the depicted example, the process generates an L1 index 110, an L2 index 118, a profile index 124, and an enhanced RAG index 128. In other implementations, the process only generates an L1 index 110 and an L2 index 118.

In the depicted example of FIG. 2, the L1 index 110 is generated by performing a screen captioning step 200 and an attribute extraction step 202 on the L0 screenshot images. The generated and extracted information can be stored in the L1 index 110 as screen summaries, where each screen summary corresponds to a respective L0 screenshot image 106. The screen summaries for the L0 screenshot images 106 can include various types of information and can be formatted in various ways. FIG. 3 illustrates one example in further detail.

FIG. 3 shows a data flow diagram of an example method for generating an L1 index 110 that stores a database of screen summaries 300. In the depicted example, a vision-language model 114 is utilized to perform the screen captioning step 200 and the attribute extraction step 202. The screen captioning step 200 can be performed in various ways. In some implementations, the vision-language model 114 is provided with a prompt to generate a caption 302 based on an input screenshot image. The prompt can provide more specific instructions, such as instructions to focus on the event, the content, the user action, etc. The prompt can also include instructions to ignore irrelevant content, such as advertisements.

The attribute extraction step 202 can also be performed in various ways. An attribute refers to a property that can be extracted from the L0 screenshot images 106. For example, an attribute field can be “user activity,” “software platform,” “user intention,” “content focus,” etc. In the depicted example, the properties are extracted from the L0 screenshot images 106 using the vision-language model 114. The vision-language model 114 can be instructed to perform the attribute extraction step 202 in various ways. In some implementations, the vision-language model 114 is provided with a prompt to extract properties 304 from a fixed set of attributes. The prompt can provide a fixed list of attributes along with example formatting. Fixing the attributes can be advantageous with implementations of smaller language models. In other implementations, the attribute fields are determined by the model 114. This enables more flexibility and the possibility of more extracted information. It can also reduce “unknown” results when the model 114 is unable to find a given property 304 from a fixed list of attributes.

The generated captions 302A-302N and the extracted properties 304A-304N are stored in the L1 index 110 as screen summaries 300A-300N. As can readily be appreciated, a caption 302 (e.g., generated through the screen captioning step 200) may be considered as one of the properties 304 of a screen summary 300. Each of the screen summaries 300A-300N is linked to a corresponding screenshot image 106A-106N from which the caption 302A-302N and properties 304A-304N are generated/extracted. These links may be stored as, for example, an identifier of the screenshot image 106. This enables the memory system to preserve the connections of screen summaries 300 to corresponding L0 screenshot images 106 without needing to store the images 106 in the L1 index. In some implementations, the screen summaries 300 are stored without references to the screenshot images 106. For example, such systems may rely on just the text information from the L1 index 110 and the L2 index 118.

Referring back to the example of FIG. 2, the L2 index 118 is generated by performing a clustering step 204 and a summarization step 206 using information from the L1 index 110. Output from the summarization step 206 can be stored in the L2 index 118 as event summaries, where each event summary corresponds to a cluster of screen summaries generated from the clustering step 204. The event summaries for the clustered screens summaries can be generated and formatted in various ways. FIG. 4 illustrates one example in further detail.

FIG. 4 shows a data flow diagram of an example method for generating an L2 index 118 that stores a database of event summaries 400. The process starts with a clustering step 204 that is performed on information from the L1 index 110 to determine a list of events 402. An event 402 refers to a clustered group of screen summaries corresponding to consecutive screenshots that share similar attributes in the L1 index 110. Events 402 can be determined in various ways. For example, information from the screen summaries of the L1 index 110 can be used.

In some implementations, the screen summaries are clustered based on a similarity threshold where screen summaries with similarity scores satisfying the threshold are clustered into an event 402. Information from the screen summaries, such as captions and extracted properties, can be used to determine the similarity score between screen summaries (and between L0 screenshot images). In the depicted example, a transformer encoder model 404 is utilized to perform the clustering step 204. The transformer encoder model 404 can be used to embed the information from the screen summaries (e.g., captions and extracted properties) into a mathematical vector. A vector cosine similarity score can then be calculated between two vectors. Screen summaries with similarity scores satisfying a predetermined threshold can be clustered together, indicating that the corresponding L0 screenshot images represent an event 402. In some implementations, the similarity scores of only certain properties are used. Weighted properties can also be used in calculating the similarity scores. For example, the clustering can be performed based on similar captions, similar software platforms, and/or similar user activities. Then properties can be weighted in the similarity score calculation, or they can be a required factor (e.g., screen summaries with similar user activities are clustered together). In some implementations, similarity scores are compared between L0 screenshot images 106 that are consecutive in time. In such cases, events 402 are temporally contiguous.

Once events 402 are determined, corresponding event summaries 400 can be generated. Event summaries 400 can be generated in various ways. In the depicted example, the process utilizes an LLM 120 that takes the events 402 (clustered screen summaries) and performs a summarization step 206 to generate an event summary for each of the determined events 402. The event summaries 400A-400N can be stored in the L2 index 118. In the depicted example, the event summaries 400A-400N are linked with corresponding events 402A-402N. This may be stored in various ways. In some implementations, the events 402 are stored as identifiers of the corresponding screen summaries (or L0 screenshot images).

Referring back to the example of FIG. 2, the process includes generating a profile index 124. In the depicted example, the profile index 124 is generated by performing a profile information extraction step on the L0 screenshot images 106. The profile information extraction step 208 can be performed in various ways. In some implementations, a vision-language model, such as a vision-LLM, is utilized to extract profile information from each of the L0 screenshot images 106. Various types of user information can be extracted. For example, factual information and inferred information from user activity can be extracted. The profile information can be formatted and stored in various ways. In some implementations, the profile information is stored as key-value pairs. The key can correspond to an attribute field, and the value can correspond to the property of the attribute field. For example, the key may be “name,” and the value is the specific name of a user. The profile information can be saved for individual users. For example, each user may have profile information containing a similar key (e.g., different users may have profile information with a “name” key).

In the depicted example, the process includes a profile index update step 210 that can be performed to update the profile index 124. For example, when new L0 screenshot images are provided, the process can extract new profile information. The new profile information can be used to update and/or reconcile the current profile information. For example, new profile information may provide a new email address that can be added to the current list of email addresses for a given user. New profile information with a new physical address can be used to update the current physical address for a user. The update process can be performed in various ways. In some implementations, for each incoming key, a top K most similar existing keys is retrieved based on semantic similarity (e.g., cosine score of embedded vectors for the keys). Any K may be used. The retrieved keys and values are concatenated, and an LLM is used to merge the existing and incoming keys. For example, the LLM can decide on whether to append the new information or overwrite the old information based on the content.

The process of FIG. 2 further includes generating an enhanced RAG index 128. The enhanced RAG index 128 can be generated in various ways. In the depicted example, an OCR step 212 is performed on the L0 screenshot images 106, and the OCR results are appended to information from the L1 index 110 to generate the enhanced RAG index 128. For example, for each of the L0 screenshot images 106, the resulting OCR text is appended to the corresponding screen summary (e.g., caption and extracted properties) and stored in the enhanced RAG index 128. This enables an enhanced RAG search as L0 screenshot images are now associated with text that does not appear on the images themselves. For example, the RAG search may connect a keyword in a query with a caption or extracted property of a given L0 screenshot image.

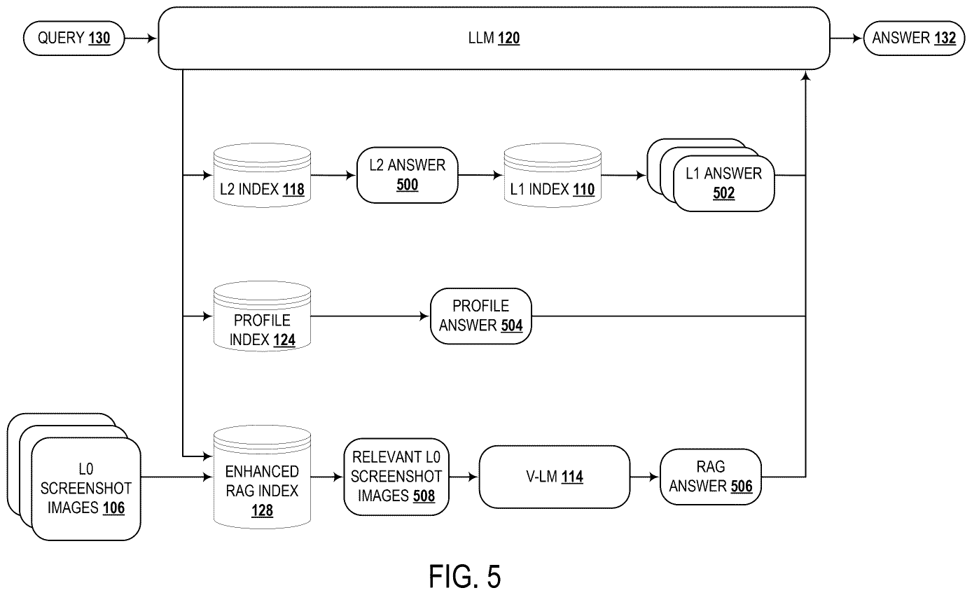

FIG. 5 shows a data flow diagram of an example method for performing question-answering queries using various indices that capture user activity as memory. In the depicted example, the process utilizes an LLM 120 along with an L1 index, and L2 index, a profile index, and an enhanced RAG index 128 for answering a query 130. The indices can be provided, for example, using the process described in FIG. 4. In other implementations, the process does not utilize the enhanced RAG index 128. In yet other implementations, the process does not utilize the enhanced RAG index 128 and the profile index 124.

The process starts with performing a semantic search on the L2 index 118 to generate an L2 answer 500. The semantic search can be performed in various ways, including but not limited to performing a lexical search, a semantic vector search, or a hybrid search. The search can be implemented as a text-only search that operates solely on the L2 index 118. The search is performed based on the query 130, returning an L2 answer 500 that contains semantically similar event summary results. In some implementations, the top K relevant event summaries are determined, and the results are summarized by the LLM 120 using the query 130 to generate the L2 answer 500. Any K may be used (e.g., K=3, K=5, etc.). Relevancy can be determined in various ways, including semantic similarity of embedded vectors. Summary of the top K relevant event summaries can be performed to remove irrelevant event summaries (e.g., if there are less than K relevant event summaries, the process may still return K results).

For each of the event summaries listed in the L2 answer 500, the process retrieves a corresponding cluster of screen summaries from the L1 index 110. Each of the clusters of screen summaries form an L1 answer 502. The L1 answer 502 can be generated using a text-only LLM model (e.g., LLM 120). In some implementations, a maximum answer length is set, and the results are truncated accordingly. For example, a maximum answer length corresponding to the maximum context length of the LLM 120 can be utilized. The LLM 120 may then use the query 130 along with the L1 answers 502 containing screen summaries corresponding to relevant events to generate an answer 132 to the query 130. To enhance the LLM's question-answering capabilities, the profiled index 124 and the enhanced RAG index 128 may also be used.

In some implementations, the process includes performing a semantic search on the profile index 124 using the query 130 to generate a profile answer 504. In further implementations, the search is configured to retrieve the top K relevant profile key-value pairs of information. Any K can be used. The top K relevant profile key-value pairs can be included in the profile answer 504. In other implementations, the top K relevant profile key-value pairs are passed to the LLM 120, and the LLM 120 determines, based on the query, the profile answer 504. For example, the LLM 120 may remove key-value pairs that it deems irrelevant. In some cases, the profile index 124 does not contain any information that can be used to answer the query 130. For example, the query 130 may be irrelevant to any user profile information. In such cases, the system can be configured to return a predetermined value, such as “unknown,” and the LLM 120 can be informed to disregard the results.

The process can also include performing an enhanced RAG search using the enhanced RAG index 128 to generate an RAG answer 506. The enhanced RAG search can be performed in various ways. In some implementations, the enhanced RAG search retrieves the top K relevant screenshot images 508 from the L0 screenshot images 106 based on the query 130. Any K can be used. Utilizing the appended information in the enhanced RAG index 128, which contains the screen summary information from the L1 index, the enhanced RAG search can result in more relevant screenshot images by enabling search for non-textual content on the screenshot images 106. The relevant L0 screenshot images 508 are then utilized, along with the query 130, by a multi-modal vision-language model 114 to generate the RAG answer 506. This enables detailed questions about specific screenshot images to be answered, especially with regards to a visual component.

The various answers generated are then combined and sent to the LLM 120 to generate an answer 132 to the query 130. In some implementations, the LLM 120 utilizes the L1 answers 502 and the query 130 to generate the answer 132. In further implementations, the LLM 120 utilizes the L1 answers 502, the profile answer 504, and the query 130 to generate the answer 132. In yet further implementations, the LLM 120 utilizes the L1 answers 502, the profile answer 504, the RAG answer 506, and the query 130 to generate the answer 132. The pipelines for generating the various answers can be operated independently for different downstream tasks. In some implementations, the LLM 120 determines and removes irrelevant information before generating a summarized answer 132 for the query 130.

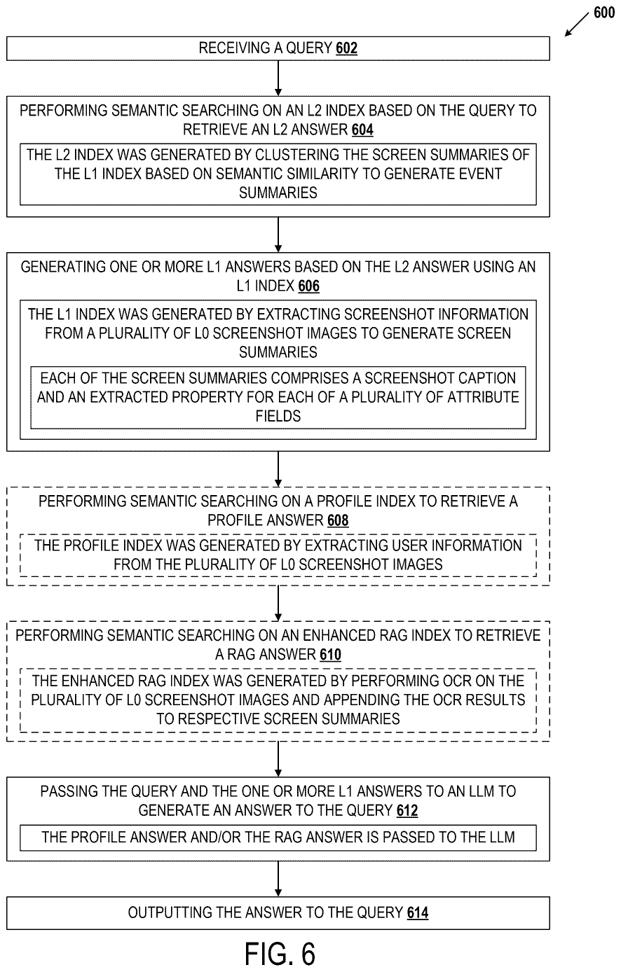

FIG. 6 shows a process flow diagram of an example method 600 for capturing user activity as memory. The example method 600 includes, at step 602, receiving a query. The query can include, for example, a request to obtain answers based on user activity on the computer. In addition to user-initiated queries, queries can be generated for downstream tasks.

The example method 600 includes, at step 604, performing semantic searching on an L2 index based on the query to retrieve an L2 answer. In some implementations, the semantic searching is performed as a text-only search on the L2 index. The L2 index can be generated in various ways. In some implementations, the L2 index is generated by clustering the screen summaries of an L1 index based on semantic similarity. The clustered screen summaries can be designated as events and summarized into event summaries. In some implementations, the events correspond to consecutive screenshot images that share similar attributes.

The example method 600 includes, at step 606, generating one or more L1 answers based on the L2 answer using an L1 index. The L1 index can be generated in various ways. In some implementations, the L1 index is generated by extracting screenshot information from a plurality of L0 screenshot images. The extracted information can be formatted into screen summaries and stored as the L1 index. The screen summaries can include various types of information, including but not limited to a screenshot caption and an extracted property for each of a plurality of attribute fields.

The example method 600 optionally includes, at step 608, performing semantic searching on a profile index to retrieve a profile answer. The profile index can be used to answer queries relating to a user. For example, an LLM can use user profile information and associated past user activity to perform recommendations. The profile index can be generated in various ways. In some implementations, the profile index is generated by extracting user information from the plurality of L0 screenshot images. In some implementations, the profile index stores key-value pairs of information pertaining to one or more user profiles. The profile index can be implemented as a dynamic user profile database that can be updated in accordance with new L0 screenshot images.

The example method 600 optionally includes, at step 610, performing semantic searching on an enhanced RAG index to retrieve a RAG answer. The enhanced RAG index can be generated in various ways. In some implementations, the enhanced RAG index is generated by performing OCR on the plurality of L0 screenshot images. The resulting OCR test is appended to respective screen summaries retrieved from the L1 index, and the concatenated results are stored as the enhanced RAG index.

The example method 600 includes, at step 612, passing the query and the one or more L1 answers to an LLM to generate an answer to the query. In some implementations, a profile answer and/or a RAG answer is passed to the LLM.

The example method 600 includes, at step 614, outputting the answer to the query.

In some embodiments, the methods and processes described herein may be tied to a computing system of one or more computing devices. In particular, such methods and processes may be implemented as a computer-application program or service, an application-programming interface (API), a library, and/or other computer-program product.

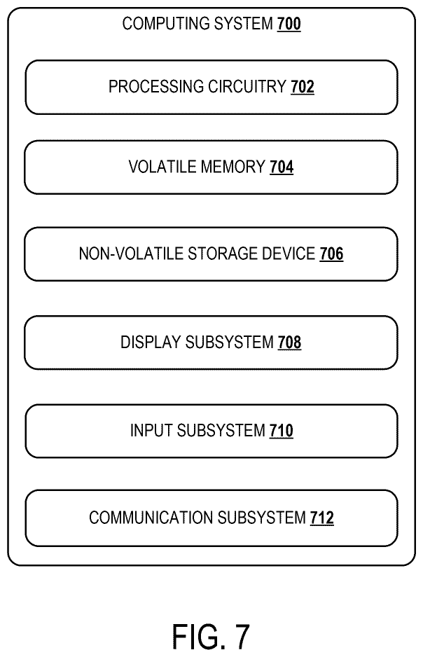

FIG. 7 schematically shows a non-limiting embodiment of a computing system 700 that can enact one or more of the methods and processes described above. Computing system 700 is shown in simplified form. Computing system 700 may embody the computing system 100 described above and illustrated in FIG. 1. Components of computing system 700 may be included in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 700 includes processing circuitry 702, volatile memory 704, and a non-volatile storage device 706. Computing system 700 may optionally include a display subsystem 708, input subsystem 710, communication subsystem 712, and/or other components not shown in FIG. 7.

Processing circuitry 702 includes a logic processor that can be implemented with one or more physical devices configured to execute instructions. For example, the processing circuitry 702 may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The processing circuitry 702 may include one or more physical processors configured to execute software instructions. Additionally or alternatively, the processing circuitry 702 may include one or more hardware logic circuits or firmware devices configured to execute hardware-implemented logic or firmware instructions. Processors of the processing circuitry 702 may be single-core or multi-core, and the instructions executed thereon may be configured for sequential, parallel, and/or distributed processing. Individual components of the processing circuitry 702 optionally may be distributed among two or more separate devices, which may be remotely located and/or configured for coordinated processing. Aspects of the processing circuitry 702 may be virtualized and executed by remotely accessible, networked computing devices configured in a cloud-computing configuration. In such a case, these virtualized aspects are run on different physical logic processors of various different machines, it will be understood.

Non-volatile storage device 706 includes one or more physical devices configured to hold instructions executable by the processing circuitry 702 to implement the methods and processes described herein. When such methods and processes are implemented, the state of non-volatile storage device 706 may be transformed—e.g., to hold different data.

Non-volatile storage device 706 may include physical devices that are removable and/or built in. Non-volatile storage device 706 may include optical memory, semiconductor memory, and/or magnetic memory, or other mass storage device technology. Non-volatile storage device 706 may include nonvolatile, dynamic, static, read/write, read-only, sequential-access, location-addressable, file-addressable, and/or content-addressable devices. It will be appreciated that non-volatile storage device 706 is configured to hold instructions even when power is cut to the non-volatile storage device 706.

Volatile memory 704 may include physical devices that include random access memory. Volatile memory 704 is typically utilized by processing circuitry 702 to temporarily store information during processing of software instructions. It will be appreciated that volatile memory 704 typically does not continue to store instructions when power is cut to the volatile memory 704.

Aspects of processing circuitry 702, volatile memory 704, and non-volatile storage device 706 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 typically implemented in software by a processor to perform a particular function using portions of volatile memory, which function involves transformative processing that specially configures the processor to perform the function. Thus, a module, program, or engine may be instantiated via processing circuitry 702 executing instructions held by non-volatile storage device 706, using portions of volatile memory 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 708 may be used to present a visual representation of data held by non-volatile storage device 706. The visual representation may take the form of a graphical user interface (GUI). As the herein described methods and processes change the data held by the non-volatile storage device, and thus transform the state of the non-volatile storage device, the state of display subsystem 708 may likewise be transformed to visually represent changes in the underlying data. Display subsystem 708 may include one or more display devices utilizing virtually any type of technology. Such display devices may be combined with processing circuitry 702, volatile memory 704, and/or non-volatile storage device 706 in a shared enclosure, or such display devices may be peripheral display devices.

When included, input subsystem 710 may comprise or interface with one or more user-input devices such as a keyboard, mouse, touch screen, camera, or microphone.

When included, communication subsystem 712 may be configured to communicatively couple various computing devices described herein with each other, and with other devices. Communication subsystem 712 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 700 to send and/or receive messages to and/or from other devices via a network such as the Internet.

The following paragraphs provide additional description of the subject matter of the present disclosure. One example includes a computing system for capturing user activity as memory, the computing system comprising: processing circuitry and memory storing instructions that, during execution, cause the processing circuitry to: receive a query; perform semantic searching on an L2 index comprising a database of event summaries based on the query to retrieve an L2 answer comprising one or more relevant event summaries from the database of event summaries; generate one or more L1 answers based on the L2 answer using an L1 index comprising a database of screen summaries associated with a plurality of L0 screenshot images, wherein each of the one or more L1 answers comprises relevant screen summaries from the database of screen summaries corresponding to L0 screenshot images associated with a respective one of the one or more relevant event summaries; pass the query and the one or more L1 answers to a large language model to generate an answer to the query; and output the answer to the query. In this example, additionally or alternatively, the L1 index was generated by, for each of the screen summaries, extracting screenshot information from a respective one of the plurality of L0 screenshot images using a vision language model. In this example, additionally or alternatively, each of the screen summaries comprises, for the respective one of the plurality of L0 screenshot images, a generated screenshot caption and an extracted property for each of a plurality of attribute fields. In this example, additionally or alternatively, the L2 index was generated by clustering the screen summaries of the L1 index based on semantic similarity to generate the database of event summaries. In this example, additionally or alternatively, generating the database of event summaries comprises summarizing each of the clustered screen summaries of the L1 index into respective event summaries. In this example, additionally or alternatively, the instructions, during execution, further cause the processing circuitry to: perform semantic searching on a profile index comprising profile information for one or more users to retrieve a profile answer, wherein the large language model generates the answer to the query based on the query, the one or more L1 answers, and the profile answer. In this example, additionally or alternatively, the profile index was generated by extracting user information from the plurality of L0 screenshot images and storing the user information as profile information, and wherein the profile information for a given user profile comprises a set of key-value pairs. In this example, additionally or alternatively, the instructions, during execution, further cause the processing circuitry to: receive new L0 screenshot images; extract new user information from the new L0 screenshot images; and update the profile index by: determining whether to append the new user information to or to overwrite a corresponding one of the key-value pairs; and updating the profile index according to the determination of whether to append the new user information to or to overwrite the corresponding one of the key-value pairs. In this example, additionally or alternatively, the instructions, during execution, further cause the processing circuitry to: perform semantic searching on an enhanced retrieved augmented generation (RAG) index based on the query to retrieve one or more relevant L0 screenshot images of the plurality of L0 screenshot images; and pass the query and the one or more relevant L0 screenshot images to a vision language model to generate a RAG answer, wherein the large language model generates the answer to the query based on the query, the one or more L1 answers, and the RAG answer. In this example, additionally or alternatively, the enhanced RAG index was generated by: generating optical character recognition text for each of the plurality of L0 screenshot images; and appending the optical character recognition text with a corresponding screen summary from the database of screen summaries to generate an enhanced RAG index.

Another example includes a method for capturing user activity as memory, the method comprising: receiving a query; performing semantic searching on an L2 index comprising a database of event summaries based on the query to retrieve an L2 answer comprising one or more relevant event summaries from the database of event summaries; generating one or more L1 answers based on the L2 answer using an L1 index comprising a database of screen summaries associated with a plurality of L0 screenshot images, wherein each of the one or more L1 answers comprises relevant screen summaries from the database of screen summaries corresponding to L0 screenshot images associated with a respective one of the one or more relevant event summaries; passing the query and the one or more L1 answers to a large language model to generate an answer to the query; and outputting the answer to the query. In this example, additionally or alternatively, the L1 index was generated by, for each of the screen summaries, extracting screenshot information from a respective one of the plurality of L0 screenshot images using a vision language model. In this example, additionally or alternatively, each of the screen summaries comprises, for the respective one of the plurality of L0 screenshot images, a generated screenshot caption and an extracted property for each of a plurality of attribute fields. In this example, additionally or alternatively, the L2 index was generated by clustering the screen summaries of the L1 index based on semantic similarity to generate the database of event summaries. In this example, additionally or alternatively, generating the database of event summaries comprises summarizing each of the clustered screen summaries of the L1 index into respective event summaries. In this example, additionally or alternatively, the method further comprises: performing semantic searching on a profile index comprising profile information for one or more users to retrieve a profile answer, wherein the large language model generates the answer to the query based on the query, the one or more L1 answers, and the profile answer. In this example, additionally or alternatively, the profile index was generated by extracting user information from the plurality of L0 screenshot images and storing the user information as profile information, and wherein the profile information for a given user profile comprises a set of key-value pairs. In this example, additionally or alternatively, the method further comprises: receiving new L0 screenshot images; extracting new user information from the new L0 screenshot images; and updating the profile index by: determining whether to append the new user information to or to overwrite a corresponding one of the key-value pairs; and updating the profile index according to the determination of whether to append the new user information to or to overwrite the corresponding one of the key-value pairs. In this example, additionally or alternatively, the method further comprises: generating optical character recognition text for each of the plurality of L0 screenshot images; appending the optical character recognition text with a corresponding screen summary from the database of screen summaries to generate an enhanced retrieved augmented generation (RAG) index; performing semantic searching on the enhanced RAG index based on the query to retrieve one or more relevant L0 screenshot images of the plurality of L0 screenshot images; and passing the query and the one or more relevant L0 screenshot images to a vision language model to generate a RAG answer, wherein the large language model generates the answer to the query based on the query, the one or more L1 answers, and the RAG answer.

Another example includes a method for capturing user activity as memory, the method comprising: generating an L1 index comprising a database of screen summaries corresponding to a plurality of L0 screenshot images by extracting screenshot information from the plurality of L0 screenshot images using a vision language model; generating an L2 index comprising a database of event summaries by clustering the screen summaries of the L1 index based on semantic similarity; generating a profile index by extracting user information from the plurality of L0 screenshot images; receiving a query; performing semantic searching on the L2 index based on the query to retrieve an L2 answer comprising one or more relevant event summaries; generating one or more L1 answers based on the L2 answer using the L1 index, wherein each of the one or more L1 answers comprises relevant screen summaries from the database of screen summaries corresponding to L0 screenshot images associated with a respective one of the one or more relevant event summaries; performing semantic searching on the profile index to retrieve a profile answer; passing the query, the one or more L1 answers, and the profile answer to a large language model to generate an answer to the query; and outputting the answer to the query.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for capturing user activity as memory, the computing system comprising:
processing circuitry and memory storing instructions that, during execution, cause the processing circuitry to:
capturing a plurality of L0 screenshot images at intervals during a user session;
using an artificial intelligence module, extract information from the plurality of L0 screenshot images to generate an L1 index comprising a database of screen summaries, each of the screen summaries corresponding to a respective one of the plurality of L0 screenshot images;
using the artificial intelligence module, generate embedded information for each of the screen summaries;
cluster the screen summaries based on semantic similarity of the embedded information of the screen summaries to generate an L2 index comprising a database of event summaries, each of the event summaries corresponding to a respective cluster of the screen summaries;
receive a query;
perform semantic searching on the L2 index based on the query to retrieve an L2 answer comprising a relevant event summary;
generate an L1 answer based on the L2 answer using the L1 index, wherein the L1 answer comprises a relevant screen summary associated with the relevant event summary;
pass the query and 7 to a large language model to generate an answer to the query; and
output the answer to the query.

2. The computing system of claim 1, wherein the L1 index was generated by, for each of the screen summaries, extracting screenshot information from a respective one of the plurality of L0 screenshot images using a vision language model.

3. The computing system of claim 2, wherein each of the screen summaries comprises, for the respective one of the plurality of L0 screenshot images, a generated screenshot caption and an extracted property for each of a plurality of attribute fields.

4. (canceled)

5. The computing system of claim 1, wherein generating the L2 index comprises summarizing each of the clustered screen summaries of the L1 index into respective event summaries.

6. The computing system of claim 1, wherein the instructions, during execution, further cause the processing circuitry to:
perform semantic searching on a profile index comprising profile information for a user to retrieve a profile answer, wherein the large language model generates the answer to the query based on the query, the L1 answer, and the profile answer.

7. The computing system of claim 6, wherein the profile index was generated by extracting user information from the plurality of L0 screenshot images and storing the user information as profile information, and wherein the profile information for a given user profile comprises a set of key-value pairs.

8. The computing system of claim 7, wherein the instructions, during execution, further cause the processing circuitry to:
receive new L0 screenshot images;
extract new user information from the new L0 screenshot images; and
update the profile index by:
determining whether to append the new user information to or to overwrite a corresponding one of the key-value pairs; and
updating the profile index according to the determination of whether to append the new user information to or to overwrite the corresponding one of the key-value pairs.

9. The computing system of claim 1, wherein the instructions, during execution, further cause the processing circuitry to:
perform semantic searching on an enhanced retrieved augmented generation (RAG) index based on the query to retrieve a relevant L0 screenshot image of the plurality of L0 screenshot images; and
pass the query and the relevant L0 screenshot image to a vision language model to generate a RAG answer, wherein the large language model generates the answer to the query based on the query, the L1 answer, and the RAG answer.

10. The computing system of claim 9, wherein the enhanced RAG index was generated by:
generating optical character recognition text for each of the plurality of L0 screenshot images; and
appending the optical character recognition text with a corresponding screen summary from the database of screen summaries to generate an enhanced RAG index.

11. A method for capturing user activity as memory, the method comprising:
capturing a plurality of L0 screenshot images at intervals during a user session;
using an artificial intelligence module, extracting information from the plurality of L0 screenshot images to generate an L1 index comprising a database of screen summaries, each of the screen summaries corresponding to a respective one of the plurality of L0 screenshot images;
using the artificial intelligence module, generating embedded information for each of the screen summaries;
clustering the screen summaries based on semantic similarity of the embedded information of the screen summaries to generate an L2 index comprising a database of event summaries, each of the event summaries corresponding to a respective cluster of the screen summaries;
receiving a query;
performing semantic searching on the L2 index based on the query to retrieve an L2 answer comprising a relevant event summary;
generating an L1 answer based on the L2 answer using the L1 index, wherein the L1 answer comprises a relevant screen summary associated with the relevant event summary;
passing the query and the L1 answer to a large language model to generate an answer to the query; and
outputting the answer to the query.

12. The method of claim 11, wherein the L1 index was generated by, for each of the screen summaries, extracting screenshot information from a respective one of the plurality of L0 screenshot images using a vision language model.

13. The method of claim 12, wherein each of the screen summaries comprises, for the respective one of the plurality of L0 screenshot images, a generated screenshot caption and an extracted property for each of a plurality of attribute fields.

14. (canceled)

15. The method of claim 11, wherein generating the L2 index comprises summarizing each of the clustered screen summaries of the L1 index into respective event summaries.

16. The method of claim 11, further comprising:
performing semantic searching on a profile index comprising profile information for a user to retrieve a profile answer, wherein the large language model generates the answer to the query based on the query, the L1 answer, and the profile answer.

17. The method of claim 16, wherein the profile index was generated by extracting user information from the plurality of L0 screenshot images and storing the user information as profile information, and wherein the profile information for a given user profile comprises a set of key-value pairs.

18. The method of claim 17, further comprising:
receiving new L0 screenshot images;
extracting new user information from the new L0 screenshot images; and
updating the profile index by:
determining whether to append the new user information to or to overwrite a corresponding one of the key-value pairs; and
updating the profile index according to the determination of whether to append the new user information to or to overwrite the corresponding one of the key-value pairs.

19. The method of claim 11, further comprising:
generating optical character recognition text for each of the plurality of L0 screenshot images;
appending the optical character recognition text with a corresponding screen summary from the database of screen summaries to generate an enhanced retrieved augmented generation (RAG) index;
performing semantic searching on the enhanced RAG index based on the query to retrieve a relevant L0 screenshot image of the plurality of L0 screenshot images; and
passing the query and the relevant L0 screenshot image to a vision language model to generate a RAG answer, wherein the large language model generates the answer to the query based on the query, the L1 answer, and the RAG answer.

20. A method for capturing user activity as memory, the method comprising:
capturing a plurality of L0 screenshot images at intervals during a user session;
generating an L1 index comprising a database of screen summaries corresponding to the plurality of L0 screenshot images by extracting screenshot information from the plurality of L0 screenshot images using a vision language model;
generating an L2 index comprising a database of event summaries by clustering the screen summaries of the L1 index based on semantic similarity;
generating a profile index by extracting user information from the plurality of L0 screenshot images;
receiving a query;
performing semantic searching on the L2 index based on the query to retrieve an L2 answer comprising a relevant event summary;
generating an L1 answer based on the L2 answer using the L1 index, wherein the L1 answer comprises a relevant screen summary associated with the relevant event summary;
performing semantic searching on the profile index to retrieve a profile answer;
passing the query, the L1 answer, and the profile answer to a large language model to generate an answer to the query; and
outputting the answer to the query.
